(19) United States
(12) Patent Application Publication
(10) Pub. No.: US 2025/0338329 A1
(43) Pub. Date: Oct. 30, 2025

(54) INFORMATION TRANSMISSION METHOD AND APPARATUS

(71) Applicant: HUAWEI TECHNOLOGIES CO., LTD., Shenzhen (CN)

(72) Inventors: Jun WANG, Shanghai (CN); Chenghui PENG, Shanghai (CN); Fei WANG, Shanghai (CN); Zhe LIU, Shanghai (CN)

(73) Assignee: HUAWEI TECHNOLOGIES CO., LTD., Shenzhen (CN)

(21) Appl. No.: 19/247,044

(22) Filed: Jun. 24, 2025

Related U.S. Application Data
(63) Continuation of application No. PCT/CN2022/142055, filed on Dec. 26, 2022.

(51) Int. Cl. H04W 76/12; H04L 65/80

(52) U.S. Cl. CPC H04W 76/12; H04L 65/80

(57) ABSTRACT

An information transmission method and an apparatus. The method includes: obtaining first information containing a mapping relationship between first task information and first bearer information; and sending, to a network device through a first bearer indicated by the first bearer information, data information that is of a first task and that is indicated by the first task information. Based on this solution, a terminal device may determine, based on a mapping relationship between task information and bearer information, a bearer that can be used for sending data information that is of a task and that corresponds to the task information. Based on the mapping relationship, transmission of the data information of the task through a plurality of bearers can be supported between the terminal device and the network device, so that transmission efficiency of the data information of the task can be improved.

### CROSS-REFERENCE TO RELATED APPLICATIONS

This application is a continuation of International Application No. PCT/CN2022/142055, filed on Dec. 26, 2022, the disclosure of which is hereby incorporated by reference in its entirety.

### TECHNICAL FIELD

The embodiments relate to the field of wireless communication technologies, and to an information transmission method and an apparatus.

### BACKGROUND

During execution of tasks such as computing, artificial intelligence (AI) inference, AI training, and data processing, task data needs to be exchanged between a network element and a user equipment (UE). For example, a UE in a computing task obtains an input from a base station side, performs computing, and reports a final computing result to the base station. For another example, a UE in an AI training task reports gradient information to a base station, and the base station delivers an updated global model to the UE. For another example, a UE in AI inference reports an inference value to a base station.

However, neither an existing signaling bearer nor an existing data bearer can directly transmit the task data. Therefore, how to exchange task information between the network element and the UE becomes an urgent problem to be resolved.

### SUMMARY

The embodiments provide an information transmission method and an apparatus to transmit task data.

According to a first aspect, an information transmission method is provided. The method may be performed by a terminal device, or may be performed by a chip/chip system. The method includes: obtaining first information, where the first information includes a mapping relationship between first task information and first bearer information; and sending, to a network device through a first bearer indicated by the first bearer information, data information that is of a first task and that is indicated by the first task information.

Based on this solution, the terminal device may determine, based on a mapping relationship between task information and bearer information, a bearer that can be used for sending data information that is of a task and that corresponds to the task information. Based on the mapping relationship, transmission of the data information of the task through a plurality of bearers can be supported between the terminal device and a network device, so that transmission efficiency of the data information of the task can be improved.

In a possible implementation, the first information further includes a mapping relationship between second task information and the first bearer information. The first task information is different from the second task information. The data information of the first task further includes the first task information.

Based on this solution, when different pieces of task information correspond to a same piece of bearer information, the terminal device may further send corresponding task information when sending data information of a task to the network device, to notify the network device of which task information the sent data information belongs to.

In a possible implementation, a first artificial intelligence (AI) model configured to execute the first task is processed. The data information of the first task further includes a processing result of processing the first AI model. Based on this solution, the terminal device supports processing the AI model, and may send the processing result of the AI model to the network device.

In a possible implementation, first configuration information is received from the network device, where the first configuration information includes a mapping relationship between the first task information and a processing manner of the AI model or a mapping relationship between the first bearer information and a processing manner of the AI model. Processing the first AI model configured to execute the first task includes: processing the first AI model based on the processing manner that is of the AI model and that corresponds to the first task information; or processing the processing manner of the AI model based on the processing manner that is of the AI model and that corresponds to the first bearer information.

Based on the foregoing solution, the network device may configure a corresponding processing manner of the AI model based on the bearer information or the task information, so that the terminal device processes the AI model based on the processing manner that is of the AI model and that corresponds to the bearer information or the task information.

In a possible implementation, the processing manner of the AI model includes a switch configuration of the AI model and/or a parameter configuration of the AI model. The switch configuration of the AI model is on or off. When the switch configuration of the AI model is on, the switch configuration of the AI model indicates to process the first AI model. When the switch configuration of the AI model is off, the switch configuration of the AI model indicates not to process the first AI model.

Based on the foregoing solution, the network device may configure the switch configuration and/or the parameter configuration of the AI model, so that the terminal device processes the AI model based on the configuration of the network device.

In a possible implementation, the processing manner of the AI model includes a switch configuration and/or a parameter configuration of one or more of model compression, model pruning, model security, model privacy, inference, data processing, and training. Based on this solution, the terminal device may perform different processing on the AI model.

In a possible implementation, the data information of the first task further includes format information, and the format information indicates a format of the processing manner. Based on this solution, the terminal device may flexibly select a format of the processing manner based on a change of an environment of the terminal device, process the AI model, and send selected format information to the network device, so that the network device determines the format information used by the terminal device to process the AI model.

In a possible implementation, the first bearer information includes one or more of a type of the first bearer, an identifier of the first bearer, and a logical channel identifier (LCID) of the first bearer.

In a possible implementation, the data information of the first task includes first indication information, and the first indication information indicates that the first bearer is a signaling bearer; or the data information of the first task includes second indication information, and the second indication information indicates that the first bearer is a data bearer.

Based on this solution, the first indication information may indicate whether the first bearer is the data bearer or the signaling bearer, thereby reducing excessive occupation of the LCID by the signaling bearer.

In a possible implementation, second configuration information is obtained, where the second configuration information includes a mapping relationship between the first bearer information and quality of service (QoS) information. Sending, to the network device through the first bearer indicated by the first bearer information, the data information that is of the first task and that is indicated by the first task information includes: sending, to the network device based on the QoS information corresponding to the first bearer information through the first bearer indicated by the first bearer information, the data information that is of the first task and that is indicated by the first task information, where the first bearer is a signaling bearer.

Based on this solution, the terminal device may send the data information of the first task based on the QoS information by using the second configuration information, to implement differentiated QoS guarantee.

In a possible implementation, the first bearer is the signaling bearer or the data bearer, and an LCID of the signaling bearer is different from an LCID of the data bearer. Based on this solution, different LCIDs are configured for the signaling bearer and the data bearer, so that excessive occupation of the LCID by the signaling bearer can be reduced.

In a possible implementation, the data information of the first task includes third indication information, the third indication information indicates the network device to transparently transmit the data information of the first task, and the first bearer is a data bearer; or the data information of the first task includes fourth indication information, the fourth indication information indicates the network device to terminate the data information of the first task, and the first bearer is a data bearer.

Based on this solution, the terminal device may indicate, to the network device based on the third indication information, whether to transparently transmit or terminate the data information carried by the first bearer, so that the data information of the task is reachable to the network device.

In a possible implementation, the data information of the first task further includes one or more of information included in the first bearer information and/or one or more of information included in the first task information. The one or more of the information included in the first bearer information and/or the one or more of the information included in the first task information indicates whether the network device terminates the first bearer, and the first bearer is a data bearer.

Based on this solution, the terminal device may indicate, to the network device based on the first bearer information and the first task information, whether to transparently transmit or terminate the data information carried by the first bearer, so that the data information of the task is reachable to the network device.

In a possible implementation, the data information of the first task further includes one or more of a node type, a node identifier, the first bearer information, and the first task information, and the node type, the node identifier, the first bearer information, and the first task information indicate a node that terminates the data information of the first task.

Based on this solution, the terminal device may indicate, to the network device based on one or more of the foregoing information, the node that terminates the data information of the first task, so that the network device routes the data information of the first task.

In a possible implementation, third configuration information is obtained, where the third configuration information includes a mapping relationship between the first bearer information and a node, and the node is configured to terminate the first bearer; and/or the third configuration information includes a mapping relationship between the first task information and a node, and the node is configured to terminate the first bearer.

Based on this solution, the terminal device may determine, based on the third configuration information, the node that terminates the data information of the first task, so that the terminal device may include related information in the data information of the first task when sending the data information of the first task, and indicate, to the network device, the node that terminates the data information of the first task.

According to a second aspect, an information transmission method is provided. The method may be performed by a network device, or may be performed by a chip/chip system. The method includes: sending first information to a terminal device, where the first information includes a mapping relationship between first task information and first bearer information; and receiving, from the terminal device through a first bearer indicated by the first bearer information, data information that is of a first task and that is indicated by the first task information.

In a possible implementation, the first information further includes a mapping relationship between second task information and the first bearer information. The first task information is different from the second task information. The data information of the first task further includes the first task information.

In a possible implementation, the data information of the first task further includes a processing result of processing, by the terminal device, a first AI model configured to executing the first task.

In a possible implementation, first configuration information is sent to the terminal device, where the first configuration information includes a mapping relationship between the first task information and a processing manner of the AI model or a mapping relationship between the first bearer information and a processing manner of the AI model.

In a possible implementation, the processing manner of the AI model includes a switch configuration of the AI model and/or a parameter configuration of the AI model. The switch configuration of the AI model is on or off. When the switch configuration of the AI model is on, the switch configuration of the AI model indicates to process the first AI model. When the switch configuration of the AI model is off, the switch configuration of the AI model indicates not to process the first AI model.

In a possible implementation, the processing manner of the AI model includes a switch configuration and/or a parameter configuration of one or more of model compression, model pruning, model security, model privacy, inference, data processing, and training.

In a possible implementation, the data information of the first task further includes format information, and the format information indicates a format of the processing manner.

In a possible implementation, the first bearer information includes one or more of a type of the first bearer, an identifier of the first bearer, and a logical channel identifier (LCID) of the first bearer.

In a possible implementation, the data information of the first task includes first indication information, and the first indication information indicates that the first bearer is a signaling bearer; or the data information of the first task includes second indication information, and the second indication information indicates that the first bearer is a data bearer.

In a possible implementation, second configuration information is sent to the terminal device, where the second configuration information includes a mapping relationship between the first bearer information and quality of service QoS information.

In a possible implementation, the first bearer is a signaling bearer or a data bearer, and a logical channel identifier (LCID) of the signaling bearer is different from an LCID of the data bearer.

In a possible implementation, the data information of the first task includes third indication information, the third indication information indicates the network device to transparently transmit the data information of the first task, and the first bearer is a data bearer; or the data information of the first task includes fourth indication information, the fourth indication information indicates the network device to terminate the data information of the first task, and the first bearer is a data bearer.

In a possible implementation, the data information of the first task further includes one or more of information included in the first bearer information and/or one or more of information included in the first task information. The one or more of the information included in the first bearer information and/or the one or more of the information included in the first task information indicates whether the network device terminates the first bearer, and the first bearer is a data bearer.

In a possible implementation, the data information of the first task further includes one or more of a node type, a node identifier, the first bearer information, and the first task information, and the node type, the node identifier, the first bearer information, and the first task information indicate a node that terminates the data information of the first task.

In a possible implementation, third configuration information is sent to the terminal device, where the third configuration information includes a mapping relationship between the first bearer information and a node, and the node is configured to terminate the first bearer; and/or the third configuration information includes a mapping relationship between the first task information and a node, and the node is configured to terminate the first bearer.

In a possible implementation, fourth configuration information is sent to each node, where the fourth configuration information includes the mapping relationship between the first bearer information and the node, and the node is configured to terminate the first bearer; and/or the fourth configuration information includes the mapping relationship between the first task information and the node, and the node is configured to terminate the first bearer.

According to a third aspect, a communication apparatus is provided, and includes a processing unit and a transceiver unit.

The processing unit is configured to obtain first information, where the first information includes a mapping relationship between first task information and first bearer information. The transceiver unit is configured to send, to a network device through a first bearer indicated by the first bearer information, data information that is of a first task and that is indicated by the first task information

In a possible implementation, the first information further includes a mapping relationship between second task information and the first bearer information. The first task information is different from the second task information. The data information of the first task further includes the first task information.

In a possible implementation, the processing unit is further configured to process a first AI model configured to execute the first task. The data information of the first task further includes a processing result of processing the first AI model.

In a possible implementation, the transceiver unit is further configured to receive first configuration information from the network device, where the first configuration information includes a mapping relationship between the first task information and a processing manner of the AI model or a mapping relationship between the first bearer information and a processing manner of the AI model. The processing unit is configured to: process the first AI model based on the processing manner that is of the AI model and that corresponds to the first task information. Alternatively, the processing unit is configured to: process the first AI model based the processing manner that is of the AI model and that corresponds to the first task information.

In a possible implementation, the processing manner of the AI model includes a switch configuration of the AI model and/or a parameter configuration of the AI model. The switch configuration of the AI model is on or off. When the switch configuration of the AI model is on, the switch configuration of the AI model indicates to process the first AI model. When the switch configuration of the AI model is off, the switch configuration of the AI model indicates not to process the first AI model.

In a possible implementation, the processing manner of the AI model includes one or more of model compression, model pruning, model security, model privacy, inference, data processing, and training.

In a possible implementation, the data information of the first task further includes format information, and the format information indicates a format of the processing manner.

In a possible implementation, the first bearer information includes one or more of a type of the first bearer, an identifier of the first bearer, and a logical channel identifier (LCID) of the first bearer.

In a possible implementation, the data information of the first task includes first indication information, and the first indication information indicates that the first bearer is a signaling bearer; or the data information of the first task includes second indication information, and the second indication information indicates that the first bearer is a data bearer.

In a possible implementation, the processing unit is further configured to obtain second configuration information, where the second configuration information includes a mapping relationship between the first bearer information and quality of service (QoS) information. The transceiver unit is configured to: send, to the network device based on the QoS information corresponding to the first bearer information through the first bearer indicated by the first bearer information, the data information that is of the first task and that is indicated by the first task information, where the first bearer is a signaling bearer.

In a possible implementation, the first bearer is the signaling bearer or the data bearer, and an LCID of the signaling bearer is different from an LCID of the data bearer.

In a possible implementation, the data information of the first task includes third indication information, the third indication information indicates the network device to transparently transmit the data information of the first task, and the first bearer is a data bearer; or the data information of the first task includes fourth indication information, the fourth indication information indicates the network device to terminate the data information of the first task, and the first bearer is a data bearer.

In a possible implementation, the data information of the first task further includes one or more of information included in the first bearer information and one or more of information included in the first task information, where one or more of the first bearer information and the first task information indicates whether the network device terminates the first bearer, and the first bearer is a data bearer.

In a possible implementation, the data information of the first task further includes one or more of a node type, a node identifier, the first bearer information, and the first task information, and the node type, the node identifier, the first bearer information, and the first task information indicate a node that terminates the data information of the first task.

In a possible implementation, the processing unit is further configured to obtain third configuration information, where the third configuration information includes a mapping relationship between the first bearer information and a node, and the node is configured to terminate the first bearer; and/or the third configuration information includes a mapping relationship between the first task information and a node, and the node is configured to terminate the first bearer.

According to a fourth aspect, a communication apparatus is provided, and includes a processing unit and a transceiver unit.

The processing unit is configured to generate first information. The transceiver unit is configured to send first information to a terminal device, where the first information includes a mapping relationship between first task information and first bearer information. The transceiver unit is further configured to receive, from the terminal device through a first bearer indicated by the first bearer information, data information that is of a first task and that is indicated by the first task information.

In a possible implementation, the first information further includes a mapping relationship between second task information and the first bearer information. The first task information is different from the second task information. The data information of the first task further includes the first task information.

In a possible implementation, the data information of the first task further includes a processing result of processing, by the terminal device, a first AI model configured to executing the first task.

In a possible implementation, the transceiver unit is further configured to send first configuration information to the terminal device, where the first configuration information includes a mapping relationship between the first task information and a processing manner of the AI model or a mapping relationship between the first bearer information and a processing manner of the AI model.

In a possible implementation, the processing manner of the AI model includes a switch configuration of the AI model and/or a parameter configuration of the AI model. The switch configuration of the AI model is on or off. When the switch configuration of the AI model is on, the switch configuration of the AI model indicates to process the first AI model. When the switch configuration of the AI model is off, the switch configuration of the AI model indicates not to process the first AI model.

In a possible implementation, the processing manner of the AI model includes one or more of model compression, model pruning, model security, model privacy, inference, data processing, and training.

In a possible implementation, the data information of the first task further includes format information, and the format information indicates a format of the processing manner.

In a possible implementation, the first bearer information includes one or more of a type of the first bearer, an identifier of the first bearer, and a logical channel identifier (LCID) of the first bearer.

In a possible implementation, the data information of the first task includes first indication information, and the first indication information indicates that the first bearer is a signaling bearer; or the data information of the first task includes second indication information, and the second indication information indicates that the first bearer is a data bearer.

In a possible implementation, the transceiver unit is further configured to send second configuration information to the terminal device, where the second configuration information includes a mapping relationship between the first bearer information and quality of service (QoS) information.

In a possible implementation, the first bearer is a signaling bearer or a data bearer, and a logical channel identifier (LCID) of the signaling bearer is different from an LCID of the data bearer.

In a possible implementation, the data information of the first task includes third indication information, the third indication information indicates a network device to transparently transmit the data information of the first task, and the first bearer is a data bearer; or the data information of the first task includes fourth indication information, the fourth indication information indicates a network device to terminate the data information of the first task, and the first bearer is a data bearer.

In a possible implementation, the data information of the first task further includes one or more of information included in the first bearer information and one or more of information included in the first task information, where one or more of the first bearer information and the first task information indicates whether the network device terminates the first bearer, and the first bearer is a data bearer.

In a possible implementation, the data information of the first task further includes one or more of a node type, a node identifier, the first bearer information, and the first task information, and the node type, the node identifier, the first bearer information, and the first task information indicate a node that terminates the data information of the first task.

In a possible implementation, the transceiver unit is further configured to send third configuration information to the terminal device, where the third configuration information includes a mapping relationship between the first bearer information and a node, and the node is configured to terminate the first bearer; and/or the third configuration information includes a mapping relationship between the first task information and a node, and the node is configured to terminate the first bearer.

In a possible implementation, the transceiver unit is further configured to send fourth configuration information to each node, where the fourth configuration information includes the mapping relationship between the first bearer information and the node, and the node is configured to terminate the first bearer; and/or the fourth configuration information includes the mapping relationship between the first task information and the node, and the node is configured to terminate the first bearer.

According to a fifth aspect, a communication apparatus is provided. The communication apparatus may be the communication apparatus according to any one of the possible implementations of the third aspect or the fourth aspect in the foregoing embodiments, or a chip disposed in the communication apparatus according to any one of the third aspect or the fourth aspect. The communication apparatus includes a communication interface and a processor, and optionally, further includes a memory. The memory is configured to store a computer program, instructions, or data. The processor is coupled to the memory and the communication interface. When the processor reads the computer program, the instructions, or the data, the communication apparatus is enabled to perform the method performed by the terminal device according to any one of the possible implementations of the first aspect, or the communication apparatus is enabled to perform the method performed by the network device according to any one of the possible implementations of the second aspect.

It should be understood that the communication interface may be implemented by using an antenna, a feeder, a codec, and the like in the communication apparatus. Alternatively, if the communication apparatus is a chip disposed in a network device or a terminal device, the communication interface may be an input/output interface of the chip, for example, an input/output pin. The communication apparatus may further include a transceiver, configured to perform communication between the communication apparatus and another device.

According to a sixth aspect, an embodiment provides a chip system. The chip system includes a processor, and may further include a memory, configured to implement the method performed by the terminal device or the network device according to any one of the possible implementations of the first aspect or the second aspect. In a possible implementation, the chip system further includes a memory, configured to store program instructions and/or data. The chip system may include a chip, or may include a chip and another discrete component.

According to a seventh aspect, the embodiments provide a non-transitory computer-readable storage medium. The non-transitory computer-readable storage medium stores a computer program or instructions. When the computer program or the instructions are run, the method performed by the terminal device or the network device in the foregoing aspects is implemented.

According to an eighth aspect, a computer program product is provided. The computer program product includes computer program code or instructions. When the computer program code or the instructions are run, the method performed by the terminal device or the network device in the foregoing aspects is performed.

According to a ninth aspect, a communication apparatus is provided. The communication apparatus includes units or modules that perform the methods in the foregoing aspects.

According to a tenth aspect, a chip system is provided, and includes a logic circuit and an input/output interface. The logic circuit is configured to perform the method performed by the terminal device or the network device. The input/output interface is configured to with another apparatus.

For beneficial effects of the second aspect to the tenth aspect and the implementations of the second aspect to the tenth aspect, refer at least to descriptions of beneficial effects of the method in the first aspect and the implementations of the first aspect.

### BRIEF DESCRIPTION OF DRAWINGS

FIG. 1 is a diagram of a communication system according to an embodiment;

FIG. 2 is a diagram of a user plane protocol and a control plane protocol of a terminal device and a network device;

FIG. 3 is a diagram of a scenario of an AI task;

FIG. 4A is a diagram of an SRB protocol stack;

FIG. 4B is a diagram of a DRB protocol stack;

FIG. 5 is an example flowchart of an information transmission method according to an embodiment;

FIG. 6 is a diagram of a MAC subhead according to an embodiment;

FIG. 7 is a diagram of a user plane protocol stack according to an embodiment;

FIG. 8 is a diagram of a protocol stack in a CU-DU split deployment scenario according to an embodiment;

FIG. 9 is a diagram of a data information routing manner according to an embodiment;

FIG. 10 is a diagram of another data information routing manner according to an embodiment;

FIG. 11 is a diagram of a communication apparatus according to an embodiment;

FIG. 12 is a diagram of another communication apparatus according to an embodiment;

FIG. 13 is a diagram of another communication apparatus according to an embodiment; and

FIG. 14 is a diagram of another communication apparatus according to an embodiment.

### DETAILED DESCRIPTION OF EMBODIMENTS

The solutions provided in embodiments are described below with reference to the accompanying drawings.

With reference to FIG. 1, the following describes a communication system to which a method provided in embodiments is applicable. Refer to FIG. 1. The communication system 100 includes a network device 101 and a terminal device 102.

The terminal device in the embodiments includes a device that provides a voice and/or data connectivity for a user. For example, the terminal device includes a device that provides a voice for the user, includes a device that provides data connectivity for the user, or includes a device that provides a voice and data connectivity for the user. For example, the terminal device may include a handheld device having a wireless connection function or a processing device connected to a wireless modem. The terminal device may be a user equipment (UE), a wireless terminal device, a mobile terminal device, a device-to-device (D2D) communication terminal device, a vehicle-to-everything (V2X) terminal device, a machine-to-machine/machine-type communication (M2M/MTC) terminal device, an internet of things (IoT) terminal device, a subscriber unit, a subscriber station, a mobile station, a remote station, an access point (AP), a remote terminal device, an access terminal device, a user terminal device, a user agent, a user device, a satellite, an uncrewed aerial vehicle, a balloon, an airplane, or the like. For example, the terminal device may include a mobile phone (or referred to as a “cellular” phone), a computer with a mobile terminal device, or a portable, pocket-sized, handheld, or computer built-in mobile apparatus. For example, the terminal device may be a device like a personal communication service (PCS) phone, a cordless phone, a session initiation protocol (SIP) phone, a wireless local loop (WLL) station, or a personal digital assistant (PDA). The terminal device may alternatively include a limited device, for example, a device with low power consumption, a device with a limited storage capability, or a device with a limited computing capability. For example, the terminal device includes an information sensing device like a barcode, radio frequency identification (RFID), a sensor, a global positioning system (GPS), or a laser scanner. By way of example, and not limitation, in embodiments, the terminal device may alternatively be a wearable device. The wearable device may also be referred to as a wearable intelligent device, an intelligent wearable device, or the like, and is a general term for wearable devices developed by intelligently designing everyday wearing by applying a wearable technology. If the various terminal devices described above are located in a vehicle (for example, placed in the vehicle or installed in the vehicle), the terminal devices may be all considered as vehicle-mounted terminal devices. For example, the vehicle-mounted terminal devices are also referred to as on-board units (OBUs).

The network device in the embodiments includes an access network (AN) device, for example, a base station or an access point, and may be a device that communicates with a wireless terminal device through an air interface in an access network by using one or more cells, or a transmission point (TRP), a transmitting point (TP), a mobile switching center, a device that functions as a base station in device-to-device (D2D), vehicle-to-everything (V2X), and machine-to-machine (M2M) communication, and the like. Alternatively, the network device may be a road side unit (RSU) in a vehicle-to-everything (V2X) technology. The network device may include an evolved NodeB (eNB or e-NodeB) in a long term evolution (LTE) system or a long term evolution-advanced (LTE-A) system, or may include a next generation NodeB (gNB) in a new radio (NR) system, or may include an access network device in a future evolved communication system like a 6th generation (6G) communication system. In addition, in a network structure, the network device may include a central unit (CU), a distributed unit (DU), or a CU and a DU. An access network device including the CU and the DU may split protocol layers of a base station. Functions of some protocol layers are centrally controlled by the CU, functions of some or all remaining protocol layers are distributed in the DU, and the CU centrally controls the DU. In addition, functions of the CU may be further divided. For example, a control plane (CP) and a user plane (UP) may be split, in other words, a CU control plane (CU-CP) and a CU user plane (CU-UP) may be split. For example, the CU-CP and the CU-UP may be implemented by different functional entities, and the CU-CP and the CU-UP may be coupled to the DU, to jointly implement functions of the network device. The CU-CP may also be divided into a CU-CP 1 and a CU-CP 2. The CU-CP 1 includes various radio resource management functions, and the CU-CP 2 includes a radio resource control (RRC) function and a function of control plane signaling at a packet data convergence protocol (PDCP) layer.

Optionally, the communication system shown in FIG. 1 may further include a core network (not shown in the figure). The core network is a core part of a mobile communication network, and a core network device plays a role of connecting the foregoing and the following, and is responsible for processing mobility management, session management, and data transmission of the terminal device.

In embodiments, an apparatus configured to implement a function of the terminal device may be the terminal device, or may be an apparatus that can support the terminal device in implementing the function, for example, a chip system. The apparatus may be installed in the terminal device or used in cooperation with the terminal device. In embodiments, the chip system may include a chip, or may include a chip and another discrete component.

In embodiments, an apparatus configured to implement a function of the network device may be the network device, or may be an apparatus that can support the network device in implementing the function, for example, a chip system. The apparatus may be installed in the network device or used in cooperation with the network device.

Embodiments are also applicable to communication between terminal devices, satellite communication, and the like.

Embodiments are applicable to both a homogeneous network scenario and a heterogeneous network scenario, and a transmission point is not limited. Embodiments may be applied to coordinated multipoint transmission between macro base stations, between micro base stations, and between a macro base station and a micro base station, and are applicable to both a frequency division duplexing (FDD) system and a time division duplexing (TDD) system. Embodiments are applicable to both a low-frequency scenario and a high-frequency scenario, terahertz, optical communication, and the like.

Embodiments are applicable to a 5G communication system, a 6G communication system, a future evolved communication system, another communication system, or the like. This is not limited. Embodiments are applicable to not only communication between a network device and a terminal device, but also communication between network devices, communication between terminal devices, and communication of an internet of vehicles, an internet of things, an industrial internet, and the like. In the following embodiments, the communication between the terminal device and the network device is used as an example for description.

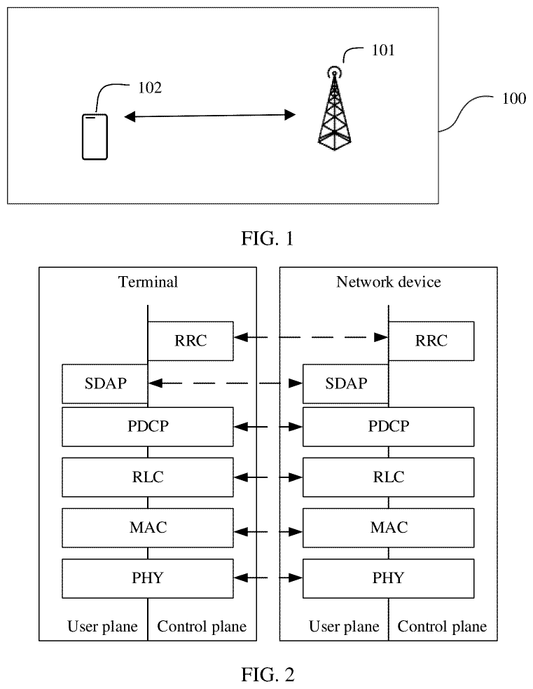

Refer to FIG. 2. The terminal device in embodiments may include a physical layer (PHY), a medium access control (MAC) layer, a radio link control (RLC) layer, a packet data convergence protocol (PDCP) layer, a radio resource control (RRC) layer, and a service data adaptation protocol (SDAP) layer. The terminal device may include a user planeprotocol and a control planeprotocol.

The network device may include a PHY, a MAC layer, an RLC layer, a PDCP layer, an RRC layer, and an SDAP layer. The network device may include a user plane protocol and a control planeprotocol. Layers of the terminal device and the network device may be connected to each other, to perform information transmission.

For ease of description, the following uses an example in which the terminal device is a terminal and the network device is a base station for description.

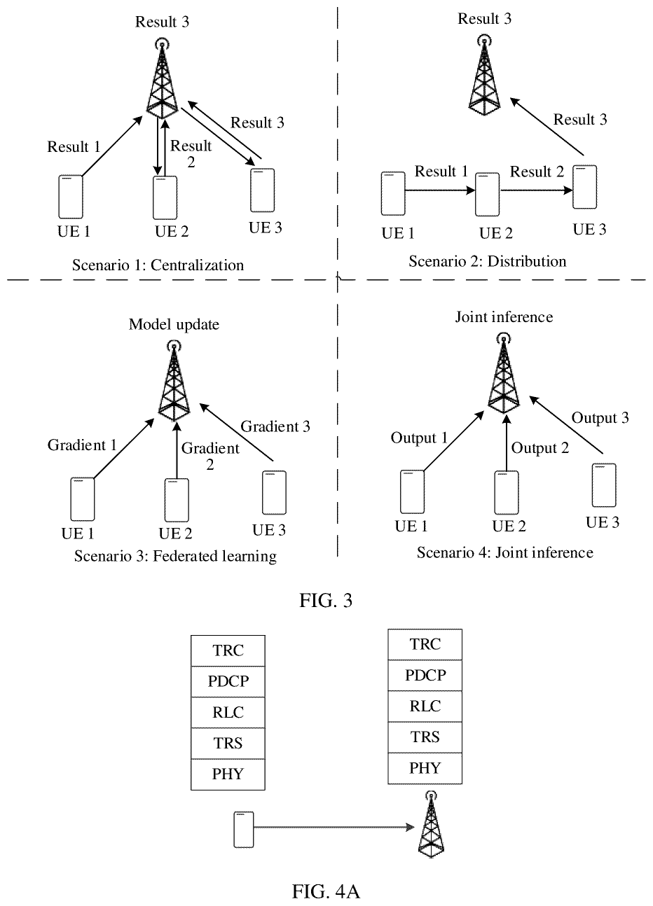

During execution of tasks such as computing, AI inference, AI training, and data processing on a network, task data needs to be exchanged between a network element and a UE. Refer to FIG. 3. A method for exchanging the task data between the network element and the UE is described.

In Scenario 1, a UE 1 completes computing and sends a result 1 to a base station. The base station sends the result 1 to a UE 2 as an input, and the UE 2 continues to perform computing. The UE 2 completes computing and sends a result 2 to the base station, and the base station sends the result 2 to a UE 3 as an input. The UE 3 continues to perform computing, and sends a result 3 to the base station. The base station uses the result 3.

Scenario 2 is similar to Scenario 1. A difference is that the result 1 and the result 2 are no longer forwarded by the base station, but directly transmitted between UEs. For example, the UE 1 completes computing and sends the result 1 to the UE 2, and the UE 2 uses the result 1 as an input to perform computing and sends the result 2 to the UE 3. The UE 3 uses the result 2 as an input to perform computing, and sends the result 3 to the base station. The base station uses the result 3.

In Scenario 3, the base station and a plurality of UEs perform federated learning, to jointly train and obtain an AI model. Due to privacy reasons, UE data cannot be directly uploaded to the base station. Therefore, UEs first perform gradient computing, and the UE 1, the UE 2, and the UE 3 report and send respective gradient values to the base station side. The base station updates a global model by using a plurality of pieces of gradient information, and then delivers an updated global model to each UE. Then, the UEs perform gradient computing based on the updated global model and send gradient information to the base station, to start a next round of model optimization process. A federated learning procedure is as follows:
S1: A UE sends a gradient to the base station.
S2: The base station performs gradient aggregation on collected gradients sent by one or more UEs, and updates an AI model, to obtain a new AI model through learning.
S3: A terminal sends the updated AI model to each UE.
S4: Each UE replaces the latest network model received in S3 with an AI model used by the UE, to perform next-step training and gradient solving.

Optionally, the UE may perform the next round of training, and the UE may perform the gradient solving and send a gradient to the base station, that is, return to perform S1.

Scenario 4 is a joint inference process. In this scenario, a plurality of UEs first perform inference, and then send respective inference results to the base station. The base station then performs inference based on the inference results of the plurality of UEs, and applies an inference result.

In the foregoing plurality of scenarios, a process of transmitting task data between the UE and the base station through an air interface is included. Therefore, how to transfer the task data through the air interface is an urgent problem to be resolved.

In an existing 4G system or 5G system, bearers between a UE and a base station are classified into a signaling bearer (SRB) and a data bearer (DRB), which are separately described below.

### 1. SRB

In the 4G system or the 5G system, the UE has three SRBs, where an SRB 0 is a signaling bearer that is used by the UE to carry an RRC message before the UE enters a connected state, for example, an RRC setup request message and an RRC setup response message carried in a random access process. After the UE enters the connected state, the UE establishes an SRB 1 based on a configuration of the base station, and the SRB 1 is used for transmitting all subsequent RRC signaling. In addition, the UE in the connected state also establishes an SRB 2 to transmit non-access stratum (NAS) signaling between the UE and a core network (CN).

To send quality of experience (QoE) to the base station, a standard further defines an SRB 4 used for sending the QoE. In a multi-connectivity (MR-DC) scenario, a UE is connected to two base stations. A bearer between the UE and a master node (MN) is an SRB 1 bearer, and a bearer between the UE and a secondary node (SN) is an SRB 3 bearer.

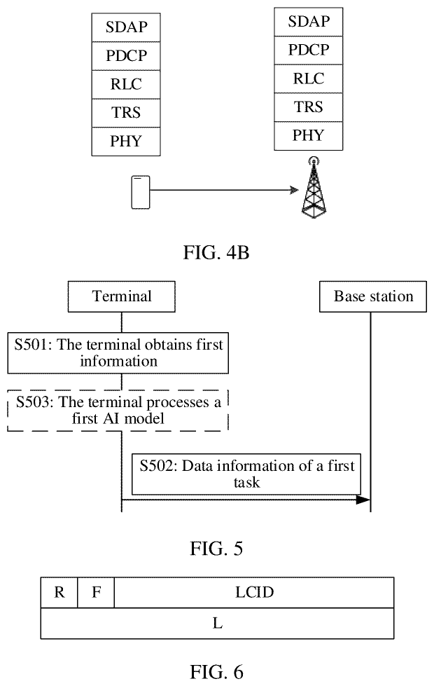

If the MR-DC scenario and QoE reporting are not considered, the SRB 1 is the only one signaling bearer between the UE in the connected state and the base station. A protocol stack corresponding to the SRB is shown in FIG. 4A. Task resource control (TRC) is obtained by enhancing an RRC layer in a 5G protocol stack, and means that control functions for tasks such as AI, computing, and data processing are added to an existing radio resource control function.

### 2. DRB

Establishment of the DRB is determined by the base station, and is determined by a quantity of services initiated by the UE and a quality of service (QoS) difference between the services. Generally, the base station places data flows of similar QoS of a plurality of services of the UE in a same DRB for transmission. Based on the configuration of the base station, the UE may establish one or more DRB bearers.

A DRB protocol stack is shown in FIG. 4B. A task resource scheduler (TRS) is evolved by enhancing a MAC layer in the 5G protocol stack. For example, a computing power scheduling function is added to an existing air interface resource scheduling function at the MAC layer.

If the task data is transmitted through the SRB or the DRB, the following problems exist:
(1) If the task data is transmitted through the SRB, currently, there is only one SRB 1 when a NAS and QoE are not considered. Therefore, a quantity of SRBs is limited, and transmission efficiency of the task data is low.

(2) If the task data is transmitted through the DRB, currently, the base station transparently transmits DRB data and forwards the data to a user plane function (UPF) network element. In other words, the base station cannot obtain the task data sent by the terminal.

Therefore, how to transmit data information of a task becomes a problem to be urgently resolved.

In view of this, embodiments provide an information transmission method. In the method, a terminal may obtain first information. The first information may include a mapping relationship between first task information and first bearer information. The terminal may send, to a base station through a first bearer indicated by the first bearer information, data information that is of a first task and that is indicated by the first task information. Based on this solution, the terminal may determine, based on a mapping relationship between task information and bearer information, a bearer that can be used for sending data information that is of a task and that corresponds to the task information. Based on the mapping relationship, transmission of the data information of the task through a plurality of bearers can be supported between the terminal and the base station, so that transmission efficiency of the data information of the task can be improved.

FIG. 5 is an example flowchart of an information transmission method according to an embodiment. The method may include the following operations.

S501: A terminal obtains first information.

For example, the terminal may receive the first information from a base station. For another example, the first information may be preconfigured, or predefined in a protocol. For another example, the terminal may receive the first information from a core network, for example, receive the first information from an AMF, an SMF, a UPF, or the like in a 5G system.

The first information may include a mapping relationship between first task information and first bearer information. The first task information may be used to describe a first task, for example, may include an identifier of the first task (task ID). The first bearer information may be used to describe a first bearer, for example, may include one or more of an identifier of the first bearer (RB ID), a logical channel identifier corresponding to the first bearer, and a type of the first bearer.

Optionally, the terminal may further obtain a mapping relationship between second task information and second bearer information. The second task information may be used to describe a second task, for example, may include an identifier of the second task. The second bearer information may be used to describe a second bearer, for example, may include one or more of an identifier of the second bearer, a logical channel identifier corresponding to the second bearer, and a type of the second bearer.

It should be noted that the mapping relationship between the first task information and the first bearer information and the mapping relationship between the second task information and the second bearer information may be indicated by a same piece of information, that is, indicated by the first information. Alternatively, the mapping relationship between the first task information and the first bearer information and the mapping relationship between the second task information and the second bearer information may be indicated by different information. This is not limited.

In the embodiments, the type of the first bearer may include an SRB, a DRB, and a first type, and the first type may be a type different from the SRB and the DRB.

In a possible case, task information may be in one-to-one correspondence with bearer information. An example in which a plurality of pieces of task information include the first task information and the second task information is used for description. For example, the first task information corresponds to the first bearer information, and the second task information corresponds to the second bearer information. For example, the first bearer and the second bearer are different bearers, data information that is of the first task and that is indicated by the first task information is sent through the first bearer indicated by the first bearer information, and data information that is of the second task and that is indicated by the second task information is sent through the second bearer indicated by the second bearer information.

In another possible case, a plurality of pieces of task information may correspond to one piece of bearer information. An example in which the plurality of pieces of task information include the first task information and the second task information is used for description. For example, the first task information and the second task information may correspond to the first bearer information. For example, the first bearer and the second bearer may be a same bearer, and both the data information that is of the first task and that is indicated by the first task information and the data information that is of the second task and that is indicated by the second task information are sent through the first bearer indicated by the first bearer information. It may be understood that, the first task information and the second task information are examples of the plurality of pieces of task information, and the plurality of pieces of task information are not limited to including only the first task information and the second task information, and may further include third task information and the like. For descriptions of task information (for example, the third task information) other than the first task information and the second task information, refer to the first task information and the second task information. To avoid redundancy, details are not described again.

S502: The terminal sends the data information of the first task to the base station.

Correspondingly, the base station receives the data information of the first task from the terminal.

For example, the terminal may send, through the first bearer indicated by the first bearer information, the data information that is of the first task and that is indicated by the first task information.

In this embodiment, the first task may include data processing, AI inference, AI training, and the like. This is not limited. Similarly, the data information of the first task may include a data processing result, an AI inference result, data needed for the AI training, an AI training result, gradient information used for the AI training, and the like. This is not limited.

Based on this solution, the terminal may determine, based on a mapping relationship between task information and bearer information, a bearer that can be used for sending data information that is of a task and that corresponds to the task information. Based on the mapping relationship, transmission of the data information of the task through a plurality of bearers can be supported between the terminal and the base station, so that transmission efficiency of the data information of the task can be improved.

In a possible implementation, when a plurality of pieces of task information corresponds to one piece of bearer information, the terminal may further send the first task information to the base station. For example, in S502, the first task information and the second task information correspond to the first bearer information, so that the data information of the first task may further include the first task information. In this way, when receiving data information that is of a task and that is sent by the terminal, the base station may determine a task to which the data information of the task belongs. Optionally, in S502, the terminal may further send data information of the second task through the first bearer, where the data information of the second task may include the second task information.

It may be understood that the first bearer in S502 may be a DRB or an SRB. The following describes two cases.

Case 1: The first bearer is an SRB.

In a possible implementation, the first bearer may be an SRB. In S501, the first information may include a mapping relationship between the first task information and first SRB information. In the embodiments, the terminal may send data information of a task through a plurality of SRBs. For example, the terminal may send the data information of the first task and the data information of the second task through a first SRB, and the terminal may send data information of a third task through a second SRB.

Currently, because only the SRB 1 exists between the terminal in the connected state and the base station for transmitting RRC control signaling, there is no QoS guarantee mechanism. However, when the terminal and the base station may need to transmit data information of a plurality of tasks, different SRBs are needed for differentiated QoS guarantee, for example, different latency and reliability requirements.

For example, the terminal may obtain configuration information. The configuration information may include a mapping relationship between the first bearer information and QoS information, for example, a mapping relationship between the first SRB information and the QoS information. In this case, when sending the data information of the first task through the first bearer, the terminal may send the data information of the first task through the first bearer based on the QoS information corresponding to the first bearer information. Optionally, the QoS information may include priority information, a QoS range (parameters), an aggregated maximum bit rate (AMBR), a peak bit rate (prioritized bit rate, PBR), and the like.

Based on Case 1, the terminal may send the data information of the tasks based on different QoS by using the mapping relationship that is between the first bearer information and the QoS information and that is indicated by the configuration information, so that data of a task having a high latency requirement or a high priority requirement can be preferentially sent.

Case 2: The first bearer is a DRB.

In a possible implementation, the first bearer may be a DRB. In S501, the first information may include a mapping relationship between the first task information and first DRB information.

Currently, the base station directly transparently transmits data carried by all DRBs. To support transmission of data information of a task between the terminal and the base station through a DRB, and final parsing and/or termination of the data information by the base station, this embodiment provides the following two manners.

Manner 1: The data information of the first task includes indication information, indicating whether to transparently transmit the data information.

For example, the data information of the first task may include third indication information, and the third indication information may indicate the base station to transparently transmit the data information of the first task. For example, the base station transparently transmits the data information of the first task to a UPF or the terminal.

For another example, the data information of the first task may include fourth indication information, and the fourth indication information may indicate the base station to parse and/or terminate the data information of the first task.

In the embodiments, parsing may be understood as performing operations such as decoding and demodulation on data information of a task, to obtain the data information of the task. Termination may be understood as not sending data information of a task to another communication device, for example, a core network device or the terminal.

Optionally, the third indication information and the fourth indication information may be implemented by using 1-bit information. For example, when a value of the 1-bit information is 0, the base station is indicated to transparently transmit the data information of the first task; or when a value of the 1-bit information is 1, the base station is indicated to parse and/or terminate the data information of the first task. On the contrary, for example, when a value of the 1-bit information is 1, the base station is indicated to transparently transmit the data information of the first task; or when a value of the 1-bit information is 0, the base station is indicated to parse and/or terminate the data information of the first task.

In another embodiment, the indication information may be implicit indication information. For example, implicit indication may be implemented based on information about whether the DRB has an SDAP layer. A DRB that carries data information of a task does not have an SDAP layer, but a DRB that carries other data information, for example, Internet access data of a user, has an SDAP layer. Therefore, if the first bearer includes SDAP layer information, for example, an SDAP header, it may be considered that the first bearer carries other data information, and the base station may transparently transmit the other data information. If the first bearer does not include SDAP layer information, it may be considered that the first bearer carries data information of a task. Therefore, the base station may parse and/or terminate the data information of the task.

Optionally, the implicit indication information may alternatively implement implicit indication based on information about whether the DRB has another layer or a task resource data (TRD) layer. The TRD layer may be a protocol layer provided in the embodiments, and is configured to process a first AI model of the first task. This is described below.

It is assumed that both a DRB that carries data information of a task and a DRB that carries other data information have SDAP layer information, but the indication information is added to an SDAP layer, a PDCP layer, or a layer above the SDAP layer, to indicate whether to transparently transmit information carried by the DRB. In other words, even if a DRB that carries other data information also has SDAP layer information, explicit indication information may indicate that the DRB is the DRB that carries the data information of the task.

In the foregoing solution, the indication information may indicate which DRB carries data information of a task and which DRB carries other data information, thereby avoiding a case in which the base station cannot learn, by parsing only an identifier of a DRB, which DRB carries data information of a task and which DRB carries other data information. In addition, the indication information further indicates whether data information needs to be transparently transmitted, parsed, or terminated by the base station.

Based on the foregoing solution, the indication information indicates whether the data information of the task is parsed and/or terminated by the base station, so that the DRB is reachable to the base station, and the base station can obtain the data information of the task.

### Manner 2:

The base station may configure a dedicated DRB for data information of a task. For example, in S501, the first bearer information may be information about a DRB that is configured by the base station for the terminal and that is dedicated to carrying the data information of the first task. In this manner, because the data information of the task and other data information do not share a DRB, before the base station configures the DRB for the terminal, different DRB attributes are determined. Therefore, the terminal may send the data information of the first task through the corresponding DRB based on the first information.

The base station may learn of the DRB information, and further learn that the DRB carries the data information of the task or other data information, to perform differentiated processing of parsing and transparent transmission. For example, the base station may transparently transmit other data information, and parse and/or terminate the data information of the task.

Based on the foregoing solution, the base station may configure the DRB for the data information of the task, so that the DRB is reachable to the base station, and the base station can obtain the data information that is of the task and that is carried by the DRB.

In a possible implementation, the SRB and the DRB share an LCID. For example, FIG. 6 shows a format of a MAC subheader. The MAC subheader in FIG. 6 may include one or more of an R field, an F field, an LCID, an extended LCID (eLCID), and an L field. The LCID may indicate a logical channel. The extended LCID may also indicate a logical channel. The L field may represent a length field, and may indicate a quantity of bytes of a MAC SDU included in a MAC subPDU or a quantity of MAC control elements (CEs) included in the MAC subPDU. The F field may represent a format field, and indicate a size of the L field. The R field may be a reserved field, for example, may be set to 0.

The MAC subheader may include the data information of the first task. The length of the LCID is 6 bits. LCID=0 is reserved for the SRB 0, and numbers of LCIDs of other SRBs and DRBs are integers ranging from 1 to 32. For example, in S502, an LCID in a MAC sub protocol data unit (subPDU) including the data information that is of the first task and that is sent by the terminal may be an integer from 1 to 32.

In another possible implementation, the SRB and the DRB may not share an LCID. In other words, an LCID when the first bearer is an SRB is different from an LCID when the first bearer is a DRB. Based on this solution, because a quantity of LCIDs shared by the SRB and the DRB is 32, if a plurality of SRBs can be established to transmit data information of a task, an excessive quantity of LCIDs of the DRB is occupied. Therefore, independent LCIDs may be set for the SRB and the DRB.

Optionally, the MAC subheader may be enhanced in the embodiments. As shown in FIG. 6, the R field may indicate that the first bearer is an SRB or the first bearer is a DRB. For example, when a value of the R field is 0, it may indicate that the first bearer is an SRB, or when a value of the R field is 1, it may indicate that the first bearer is a DRB. On the contrary, when a value of the R field is 1, it may indicate that the first bearer is an SRB, or when a value of the R field is 0, it may indicate that the first bearer is a DRB.

In an example, currently, a maximum quantity of concatenated data packets supported by the PDCP layer is 16, and a maximum data amount of each data packet is 9K. Therefore, an ultra-large model or ultra-large data cannot be carried. In the embodiments, the RRC layer supports concatenation. For example, concatenation is implemented through a secondary node (SN). In the embodiments, a maximum quantity of supported SNs may be greater than 16. In this way, the terminal may send an ultra-large model or ultra-large data to the base station.

It may be understood that the concatenation may be understood as combining a plurality of data packets into a large data packet. The plurality of data packets may be obtained by segmenting one piece of data and then performing some operations such as encoding or modulation. Alternatively, the plurality of data packets may be from different data, for example, data information of different tasks.

Optionally, the embodiment shown in FIG. 5 may further include the following operation S503.

S503: The terminal processes the first AI model.

For example, the terminal may process the first AI model configured to execute the first task. The data information of the first task in S502 may include a processing result of processing the first AI model by the terminal.

In a possible implementation, the terminal may process the first AI model based on a configuration of the base station. The base station may configure the bearer information or the task information. For example, the base station may send first configuration information to the terminal, where the first configuration information may include a mapping relationship between the first task information and a processing manner of the AI model. The terminal may process the first AI model of the first task based on the processing manner corresponding to the first task information.

Alternatively, the first configuration information may include a mapping relationship between the first bearer information and a processing manner of the AI model. The terminal may process the first AI model of the first task based on the processing manner corresponding to the first bearer information.

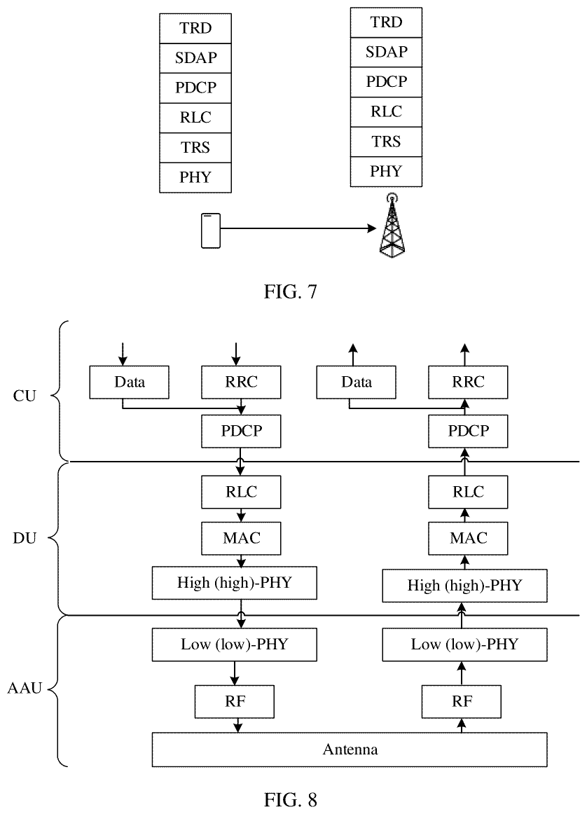

Currently, the RRC layer does not support a function of processing the AI model. Therefore, the function may be newly defined at the RRC layer, or a layer is added above or below the RRC layer, to support the function of processing the AI model. Optionally, a layer may be further added to a user plane protocol stack, to support the function of processing the AI model. As shown in FIG. 7, a TRD layer is added above the SDAP layer.

In the embodiments, the processing manner of the AI model may include one or more of model compression, model pruning, model security, model privacy, inference, data processing, and model training.

Based on the foregoing solution, a layer is added or a function is newly defined at the RRC layer, to implement the function of processing the AI model, to process the AI model.

Optionally, the base station may configure a switch configuration and a parameter configuration of the processing manner of the AI model. For example, the first configuration information may include a switch configuration of the AI model and/or a parameter configuration of the AI model. The switch configuration may be on or off. When the switch configuration is on, the terminal is indicated to process the AI model based on the processing manner. When the switch configuration of the processing mode is off, the terminal is indicated not to perform corresponding processing on the AI model.

It may be understood that the parameter configuration may include a parameter needed by the terminal to process the AI model. For example, when the processing manner includes the model training, the parameter configuration may include a parameter used by the terminal to perform model training. For another example, when the processing manner includes the inference, the parameter configuration may include an input parameter used by the terminal to perform inference. For another example, when the processing manner includes the model pruning, the parameter configuration may include a location at which pruning needs to be performed, a size of a pruned model, or the like. For another example, when the processing manner includes the model compression, the parameter configuration may include one or more of a model compression manner, an algorithm identifier, a model compression parameter, and the like.

In a possible case, when processing the AI model, the terminal may process the AI model based on a preconfigured format. For example, when the processing manner includes the model compression, the terminal may process the AI model according to a preset compression algorithm. For another example, when the processing manner includes the data processing, the terminal may process the data based on a preset format.

Optionally, to enhance flexibility, the terminal may flexibly select a format based on a change of an environment of the terminal, for example, a change of a location, a channel condition, or signal strength, to process the AI model. Therefore, the terminal may send format information to the base station, that is, format information used to process the AI model. For example, the terminal may include the format information in the data information of the first task.

In a possible implementation, the data information of the first task may carry routing information. The routing information may indicate a node that parses and/or terminates the data information of the first task. The node may include a node of the core network device, for example, an access and mobility management function (AMF) network element, a session management function (SMF) network element, or a UPF, or may include a node of the base station, for example, a central unit (CU), a distributed unit (DU), a central unit-control plane (CU control plane, CU-CP), or a central unit-user plane (CU user plane, CU-UP). Based on this solution, the base station may determine, based on the routing information in the data information of the first task, the node that parses and/or terminates the data information of the first task, and forward the data information of the first task to the corresponding node.

For example, the data information of the first task may include one or more of a node type, a node identifier, the first bearer information, and the first task information. The one or more of the node type, the node identifier, the first bearer information, and the first task information may indicate the node that parses and/or terminates the data information of the first task. The first bearer information and/or the first task information may have a mapping relationship with the node. Therefore, the node that parses and/or terminates the data information of the first task may be determined based on a mapping relationship between the first bearer information and the node and/or a mapping relationship between the first task information and the node.

It may be understood that the mapping relationship between the first bearer information and the node and/or the mapping relationship between the first task information and the node in the embodiments may be indicated, to the terminal, by the base station, for example, a RAN, a CU, a DU, a CU-CP, or a CU-UP, or by the core network device, for example, an AMF, a UPF, or an SMF. For example, the base station or the core network device may send third configuration information to the terminal. The third configuration information may include the mapping relationship between the first bearer information and the node, and/or the third configuration information may include the mapping relationship between the first task information and the node. In this way, the terminal may learn of the node that parses and/or terminates the data information of the first task, and include the data information of the first task in the first bearer indicated by the corresponding first bearer information. Optionally, the mapping relationship may alternatively be preconfigured for the terminal instead of being transmitted through signaling.

Optionally, each node in the embodiments may receive fourth configuration information, where the fourth configuration information may include the mapping relationship between the first bearer information and the node, and/or the fourth configuration information may include the mapping relationship between the first task information and the node. The fourth configuration information may be sent by a node of the base station to each node, for example, sent by the RAN to the CU, the DU, the CU-CP, the CU-UP, or the core network device, for example, the AMF, the UPF, or the SMF. Alternatively, the fourth configuration information may be sent by the core network device, for example, the AMF, to the UPF, the SMF, the RAN, the CU, the DU, the CU-CP, or the CU-UP. In the embodiments, the node that sends the fourth configuration information is not limited.

The following explains and describes the routing information by using different examples.

### Example 1

5G supports a CU/DU split deployment scenario. CUs are generally deployed in a centralized cloud-based mode, which facilitates resource sharing. DUs use an edge deployment mode, are closer to a service end, and has low latency. In a 5G protocol, a plurality of CU/DU splitting manners are discussed, and, only a solution in which a CU is deployed at a PDCP layer or above and a DU is deployed at an RLC layer or below is standardized, as shown in FIG. 8.

Based on the foregoing CU/DU split protocol stack, it can be understood that protocol layers between the terminal and the DU include PHY, MAC, and RLC, and protocol layers between the terminal and the CU include PDCP and RRC, PDCP and SDAP, and the like. Therefore, the terminal may communicate with the DU in the following manners:

Manner 1: An SRB is used for carrying. In other words, the first bearer is an SRB.

For example, the terminal may send the data information of the first task to the CU through the SRB, and the CU may forward the data information of the first task to the DU.

For example, the terminal sends the data information of the first task to the CU through a TRC layer. After receiving the data information, the CU parses the data information, learns that the data information needs to be forwarded to the DU, and forwards the message through an interface (for example, an F1 interface in 5G) between the CU and the DU.

It may be understood that there are the following manners in which the CU identifies, based on specific information, that the data information of the first task needs to be forwarded to the DU:

### Explicit Manner

For example, the data information of the first task explicitly carries a node identifier and/or a node type, that is, an identifier of the DU and/or a node type that is the DU. In this way, after receiving the first bearer, the CU may determine, based on the node identifier and/or the node type carried in the data information of the first task, whether the data information needs to be forwarded to the DU.

### Implicit Manner

For example, the data information of the first task may carry the first task information and/or the first bearer information, and the CU identifies, based on the first task information and/or the first bearer information, whether the data information needs to be forwarded to the DU. For example, when the data information of the first task carries the first task information, the CU may determine, based on the mapping relationship between the first task information and the node, whether the data information needs to be forwarded to the DU. For another example, when the data information of the first task carries the first bearer information, the CU may determine, based on the mapping relationship between the first bearer information and the node, whether to forward the data information to the DU.

It may be understood that a method for determining, by the CU, whether to forward the data information of the first task to the DU is described in Manner 1. A method for determining, by the CU, whether to forward the data information of the first task to another node like the AMF, the UPF, or the SMF may also be implemented in Manner 1. Similarly, another node like the DU, the core network device, the CU-CP, or the CU-UP, may also determine, in Manner 1, whether the data information of the first task needs to be forwarded.

Manner 2: A TRS/PHY is used for carrying.

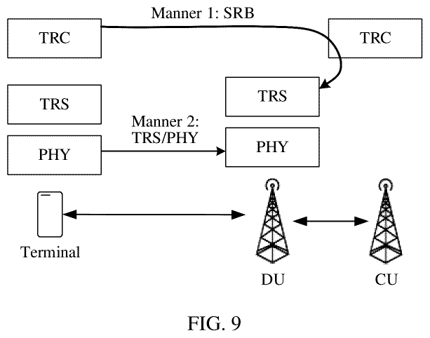

Refer to FIG. 9. The data information of the first task is carried by using DCI, UCI, or a MAC CE, and a DU may parse and process the DCI, the UCI, or the MAC CE.

Manner 3: A DRB or an SRB is used for carrying. In other words, the first bearer is a DRB or an SRB.

In the embodiments, the DU may be enhanced, so that the DU has a complete capability of transmitting the data information of the task through the DRB and/or the SRB. In this way, when the DU identifies that the data information of the first task is sent by the terminal to the DU, the data information does not need to be forwarded to the CU, and the CU does not need to forward the data information to the DU.

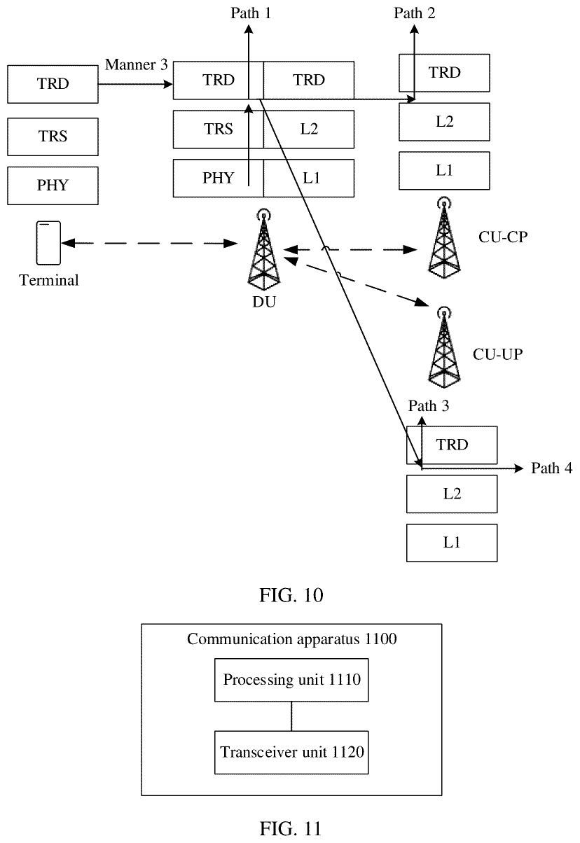

Refer to FIG. 10. The terminal may execute the first task by using the TRD layer, and may send the data information of the first task to the DU through the DRB or the SRB. The DU shown in FIG. 10 may be an enhanced DU. The DU may determine a path 1 based on the first bearer information and/or the first task information carried in the data information of the first task. For example, the DU parses and/or terminates the data information of the first task. Alternatively, a path 2 may be determined. For example, the DU forwards the data information of the first task to a CU-CP. Alternatively, a path 3 or a path 4 may be determined. For example, the DU forwards the data information of the first task to a CU-UP.

### Example 2

For a CU deployed in a centralized mode, a 5G standard further supports further division of the CU into a CU-CP and a CU-UP, to support independent deployment and independent upgrade of the CU-CP and the CU-UP. The CU-CP is responsible for control signaling corresponding to an air interface control plane protocol stack, for example, a PDCP layer and an RRC layer. The CP-UP is responsible for data parts corresponding to an air interface user plane protocol stack, for example, a PDCP layer and an SDAP layer.

The terminal and the CU-CP exchange data information of a task in the following two manners:

Manner 1: An SRB is used for carrying. In other words, the first bearer is an SRB.

For implementation, refer to Manner 1 in Example 1.

Manner 2: A DRB is used for carrying. In other words, the first bearer is a DRB.

Because the current CU-CP in 5G has only an SRB bearer, the CU-CP may be enhanced as the DU in Example 1, so that the CU-CP integrates a capability of transmitting data information of a task through the DRB.

Refer to FIG. 10. The terminal may execute the first task by using the TRD layer, and may send the data information of the first task to the DU through the DRB or the SRB. The DU shown in FIG. 10 may determine a path 1 based on the first bearer information and/or the first task information carried in the data information of the first task. For example, the DU parses and/or terminates the data information of the first task. Alternatively, a path 2 may be determined. For example, the DU forwards the data information of the first task to a CU-CP. The CU-CP shown in FIG. 10 may be an enhanced CU-CP. The CU-CP determines, based on the first bearer information and/or the first task information carried in the data information of the first task, that the CU-CP parses and/or terminates the data information of the first task. Alternatively, a path 3 or a path 4 may be determined. For example, the DU forwards the data information of the first task to a CU-UP.

### Example 3

The terminal and the CU-UP exchange data information of a task in the following two manners:

Manner 1: An SRB is used for carrying. In other words, the first bearer is an SRB.

Because the current CU-CP has only a DRB, the CU-UP may be enhanced, so that the CU-UP has a capability of transmitting data information of a task through the SRB. The enhanced CU-UP may be implemented with reference to Manner 1 in Example 1.

Manner 2: A DRB is used for carrying. In other words, the first bearer is a DRB.

Because the current CU-UP in 5G has a DRB bearer, the CU-UP may be enhanced as the DU in Example 1, so that the CU-UP integrates a capability of transmitting data information of a task through the DRB.

Refer to FIG. 10. The terminal may execute the first task by using the TRD layer, and may send the data information of the first task to the DU through the DRB or the SRB. The DU shown in FIG. 10 may determine a path 1 based on the first bearer information and/or the first task information carried in the data information of the first task. For example, the DU parses and/or terminates the data information of the first task. Alternatively, a path 2 may be determined. For example, the DU forwards the data information of the first task to a CU-CP. Alternatively, a path 3 or a path 4 may be determined. For example, the DU forwards the data information of the first task to a CU-UP. The CU-UP shown in FIG. 10 may be an enhanced CU-UP. The CU-UP determines, based on the first bearer information and/or the first task information carried in the data information of the first task, that the CU-UP parses and/or terminates the data information of the first task.

The following describes a communication apparatus for implementing the foregoing method in embodiments with reference to the accompanying drawings. Therefore, all the foregoing content may be used in the following embodiments. Repeated content is not described again.

FIG. 11 is a block diagram of a communication apparatus 1100 according to an embodiment. The communication apparatus 1100 may correspondingly implement functions or steps implemented by the terminal device or the network device in the foregoing method embodiments. The communication apparatus may include a processing unit 1110 and a transceiver unit 1120. Optionally, a storage unit may be further included. The storage unit may be configured to store instructions (code or a program) and/or data. The processing unit 1110 and the transceiver unit 1120 may be coupled to the storage unit. For example, the processing unit 1110 may read the instructions (the code or the program) and/or the data in the storage unit, to implement a corresponding method. The foregoing units may be independently disposed, or may be partially or completely integrated.

In some possible implementations, the communication apparatus 1100 can correspondingly implement behavior and functions of the terminal device in the foregoing method embodiments. For example, the communication apparatus 1100 may be a terminal device, or may be a component (for example, a chip or a circuit) used in the terminal device. The transceiver unit 1120 may be configured to perform all receiving or sending operations performed by the terminal device in the embodiment shown in FIG. 5, for example, S502 in the embodiment shown in FIG. 5, and/or configured to support another process of the technology described in the embodiments. The processing unit 1110 is configured to perform all operations other than the receiving or sending operations performed by the terminal device in the embodiment shown in FIG. 5, for example, S501 in the embodiment shown in FIG. 5, and/or configured to support another process of the technology described in the embodiments.

For example, the processing unit 1110 is configured to obtain first information, where the first information includes a mapping relationship between first task information and first bearer information. The transceiver unit 1120 is configured to send, to a network device through a first bearer indicated by the first bearer information, data information that is of a first task and that is indicated by the first task information.

In some possible implementations, the communication apparatus 1100 can correspondingly implement behavior and functions of the network device in the foregoing method embodiments. For example, the communication apparatus 1100 may be a network device, or may be a component (for example, a chip or a circuit) used in the network device. The transceiver unit 1120 may be configured to perform all receiving or sending operations performed by the network device in the embodiment shown in FIG. 5, for example, S502 in the embodiment shown in FIG. 5, and/or configured to support another process of the technology described in the embodiments. The processing unit 1110 is configured to perform all operations other than the receiving or sending operations performed by the network device in the embodiment shown in FIG. 5.

For example, the processing unit 1110 is configured to generate first information. The transceiver unit 1120 is configured to send first information to a terminal device, where the first information includes a mapping relationship between first task information and first bearer information. The transceiver unit 1120 is further configured to receive, from the terminal device through a first bearer indicated by the first bearer information, data information that is of a first task and that is indicated by the first task information.

For operations performed by the processing unit 1110 and the transceiver unit 1120, refer to the related descriptions in the foregoing method embodiments.

It should be understood that the processing unit 1110 in this embodiment may be implemented by a processor or a processor-related circuit component, and the transceiver unit 1120 may be implemented by a transceiver, a transceiver-related circuit component, or a communication interface.

Based on a same concept, as shown in FIG. 12, an embodiment provides a communication apparatus 1200. The communication apparatus 1200 includes a processor 1210. Optionally, the communication apparatus 1200 may further include a memory 1220, configured to: store instructions executed by the processor 1210, store input data needed by the processor 1210 to run instructions, or store data generated after the processor 1210 runs instructions. The processor 1210 may implement the method shown in the foregoing method embodiments by using the instructions stored in the memory 1220.

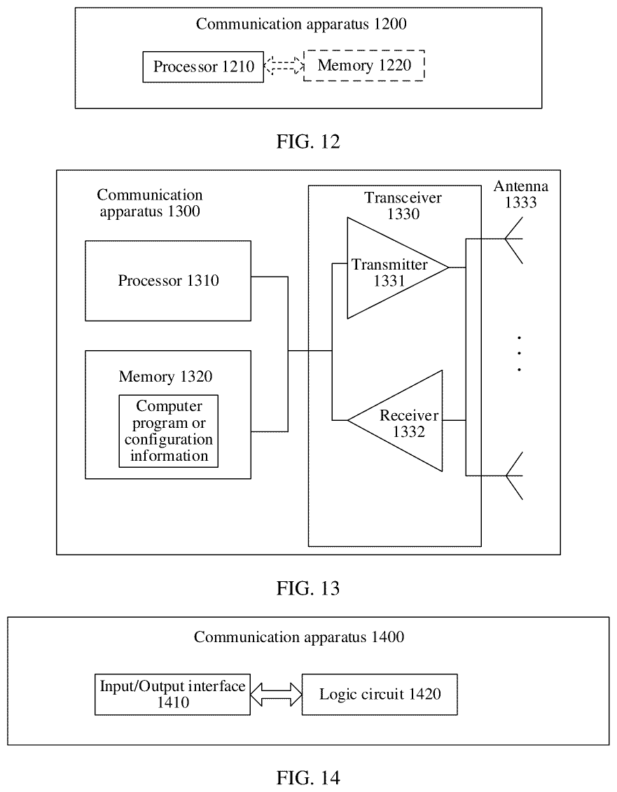

Based on a same concept, as shown in FIG. 13, an embodiment provides a communication apparatus 1300. The communication apparatus 1300 may be a chip or a chip system. Optionally, in this embodiment, the chip system may include a chip, or may include a chip and another discrete component.

The communication apparatus 1300 may include at least one processor 1310. The processor 1310 is coupled to a memory. Optionally, the memory may be located inside the apparatus, or may be located outside the apparatus. For example, the communication apparatus 1300 may further include at least one memory 1320. The memory 1320 stores a computer program, configuration information, a computer program or instructions, and/or data necessary for implementing any one of the foregoing embodiments. The processor 1310 may execute the computer program stored in the memory 1320, to complete the method in any one of the foregoing embodiments.

The coupling in this embodiment may be an indirect coupling or a communication connection between apparatuses, units, or modules in an electrical form, a mechanical form, or another form, and is used for information exchange between the apparatuses, the units, or the modules. The processor 1310 may cooperate with the memory 1320. A specific connection medium between a transceiver 1330, the processor 1310, and the memory 1320 is not limited.

The communication apparatus 1300 may further include the transceiver 1330, and the communication apparatus 1300 may exchange information with another device through the transceiver 1330. The transceiver 1330 may be a circuit, a bus, a transceiver, or any other apparatus that may be configured to exchange information, or is referred to as a signal transceiver unit. As shown in FIG. 13, the transceiver 1330 includes a transmitter 1331, a receiver 1332, and an antenna 1333. In addition, when the communication apparatus 1300 is a chip-type apparatus or a circuit, the transceiver in the communication apparatus 1300 may alternatively be an input/output circuit and/or a communication interface, and may input data (or referred to as “receive data”) and output data (or referred to as “send data”). The processor is an integrated processor, a microprocessor, or an integrated circuit, and the processor may determine output data based on input data.

In a possible implementation, the communication apparatus 1300 may be used in a terminal device. For example, the communication apparatus 1300 may be a terminal device, or may be an apparatus that can support a terminal device in implementing functions of the terminal device in any one of the foregoing embodiments. The memory 1320 stores a necessary computer program, a computer program or instructions, and/or data for implementing functions of the terminal device in any one of the foregoing embodiments. The processor 1310 may execute the computer program stored in the memory 1320, to complete the method performed by the terminal device in any one of the foregoing embodiments.

In a possible implementation, the communication apparatus 1300 may be used in a network device. For example, the communication apparatus 1300 may be a network device, or may be an apparatus that can support a network device in implementing functions of the network device in any one of the foregoing embodiments. The memory 1320 stores a necessary computer program, a computer program or instructions, and/or data for implementing functions of the network device in any one of the foregoing embodiments. The processor 1310 may execute the computer program stored in the memory 1320, to complete the method performed by the network device in any one of the foregoing embodiments.

The communication apparatus 1300 provided in this embodiment may be used in the network device to complete the method performed by the network device, or may be used in the terminal device to complete the method performed by the terminal device. Therefore, for effects that can be achieved by the communication apparatus 1300, refer at least to the foregoing method embodiments. Details are not described herein again.

In embodiments, the processor may be a general-purpose processor, a digital signal processor, an application-specific integrated circuit, a field programmable gate array or another programmable logic device, a discrete gate or transistor logic device, or a discrete hardware component, and may implement or execute the methods, steps, and logical block diagrams provided in embodiments. The general-purpose processor may be a microprocessor or any conventional processor or the like. The steps of the method with reference to embodiments may be directly performed by a hardware processor, or may be performed by using a combination of hardware in the processor and a software module.

In embodiments, the memory may be a non-volatile memory, for example, a hard disk drive (HDD) or a solid-state drive (SSD), or may be a volatile memory, for example, a random access memory (RAM). Alternatively, the memory may be any other medium that can be configured to carry or store expected program code in a form of an instruction or a data structure and that can be accessed by a computer, but is not limited thereto. The memory in embodiments may alternatively be a circuit or any other apparatus that can implement a storage function, and is configured to store a computer program, a computer program or instructions, and/or data.

Refer to FIG. 14. Based on the foregoing embodiments, an embodiment further provides another communication apparatus 1400, including an input/output interface 1410 and a logic circuit 1420. The input/output interface 1410 is configured to receive code instructions and transmit the code instructions to the logic circuit 1420. The logic circuit 1420 is configured to run the code instructions to perform the method performed by the network device or the terminal device in any one of the foregoing embodiments.

The following describes in detail an operation performed by the communication apparatus used in a network device or a terminal device.

In an optional implementation, the communication apparatus 1400 may be used in the network device to perform the method performed by the network device, for example, the method performed by the network device in the embodiment shown in FIG. 5.

The logic circuit 1420 is configured to generate first information. The input/output interface 1410 is configured to output the first information to a terminal device, where the first information includes a mapping relationship between first task information and first bearer information. The input/output interface 1410 is further configured to input, through a first bearer indicated by the first bearer information, data information that is of a first task and that is indicated by the first task information and that is from the terminal device.

The communication apparatus 1400 provided in this embodiment may be used in the network device to complete the method performed by the network device. Therefore, for effects that can be achieved by the communication apparatus 1400, refer at least to the foregoing method embodiments. Details are not described herein again.

In an optional implementation, the communication apparatus 1400 may be used in the terminal device, to perform the method performed by the terminal device, for example, the method performed by the terminal device in the embodiment shown in FIG. 5.

The logic circuit 1420 is configured to obtain first information, where the first information includes a mapping relationship between first task information and first bearer information. The input/output interface 1410 is configured to output, to a network device through a first bearer indicated by the first bearer information, data information that is of a first task and that is indicated by the first task information.

The communication apparatus 1400 provided in this embodiment may be used in the terminal device to complete the method performed by the terminal device. Therefore, for effects that can be achieved by the communication apparatus 1400, refer at least to the foregoing method embodiments. Details are not described herein again.

Based on the foregoing embodiments, an embodiment further provides a communication system. The communication system includes at least one communication apparatus used in a network device and at least one communication apparatus used in a terminal device. For effects that can be achieved by the communication system, refer at least to the foregoing method embodiments. Details are not described herein again.

Based on the foregoing embodiments, an embodiment further provides a non-transitory computer-readable storage medium. The non-transitory computer-readable storage medium stores a computer program or instructions. When the instructions are executed, the method performed by the network device or the method performed by the terminal device in any one of the foregoing embodiments is implemented. The non-transitory computer-readable storage medium may include any medium that can store program code, for example, a USB flash drive, a removable hard disk drive, a read-only memory, a random access memory, a magnetic disk, or an optical disc.

To implement the functions of the communication apparatuses in FIG. 11 to FIG. 14, an embodiment further provides a chip, including a processor, configured to support the communication apparatuses in implementing the functions of the network device or the terminal device in the foregoing method embodiments. In a possible design or implementation, the chip is connected to a memory, or the chip includes a memory. The memory is configured to store a computer program or instructions and data that are necessary for the communication apparatuses.

A person skilled in the art should understand that embodiments may be provided as a method, a system, or a computer program product. Therefore, the embodiments may use a form of hardware only embodiments, software only embodiments, or embodiments with a combination of software and hardware. In addition, the embodiments may use a form of a computer program product that is implemented on one or more computer-usable storage media (including, but not limited to, a disk memory, a CD-ROM, an optical memory, and the like) that include computer-usable program code.

The embodiments are described with reference to the flowcharts and/or block diagrams of the method, the device (system), and the computer program product according to embodiments. It should be understood that a computer program or instructions may be used to implement each procedure and/or each block in the flowcharts and/or the block diagrams and a combination of a procedure and/or a block in the flowcharts and/or the block diagrams. The computer program or the instructions may be provided for a general-purpose computer, a dedicated computer, an embedded processor, or a processor of another programmable data processing device to generate a machine, so that the instructions executed by the computer or the processor of another programmable data processing device generate an apparatus for implementing a specific function in one or more procedures in the flowcharts and/or in one or more blocks in the block diagrams.

The computer program or the instructions may alternatively be stored in a non-transitory computer-readable memory that can indicate the computer or the another programmable data processing device to work in a specific manner, so that the instructions stored in the non-transitory computer-readable memory generate an artifact that includes an instruction apparatus. The instruction apparatus implements a specific function in one or more procedures in the flowcharts and/or in one or more blocks in the block diagrams.

The computer program or the instructions may alternatively be loaded onto the computer or the another programmable data processing device, so that a series of operation steps are performed on the computer or the another programmable device to generate computer-implemented processing. Therefore, the instructions executed on the computer or the another programmable device provide steps for implementing a specific function in one or more procedures in the flowcharts and/or in one or more blocks in the block diagrams.

It should be understood that the term “and/or” describes only an association relationship between associated objects and represents that three relationships may exist. For example, A and/or B may represent the following three cases: only A exists, both A and B exist, and only B exists. In addition, the character “/” may represent “and/or”. For example, A/B represents A and/or B.

It should be understood that, in embodiments, “B corresponding to A” indicates that B is associated with A, and B may be determined based on A. However, it should be further understood that determining B based on A does not mean that B is determined based only on A. B may alternatively be determined based on A and/or other information.

“A plurality of” refers to two or more than two.

In embodiments, descriptions such as “first” and “second” are merely intended to illustrate and distinguish between described objects, do not indicate a sequence or indicate a particular limitation on a quantity of described objects in embodiments, and cannot constitute any limitation.

Mutual reference may be made to content in embodiments. Unless otherwise stated or there is a logical conflict, terms and/or descriptions in different embodiments are consistent and may be mutually referenced, and features in different embodiments may be combined based on an internal logical relationship thereof, to form a new embodiment.

It may be understood that, in embodiments, the terminal device and/or the network device may perform some or all steps in embodiments. These steps or operations are merely examples. In embodiments, other operations or variations of various operations may be further performed. In addition, the steps may be performed in a sequence different from a sequence presented in embodiments, and not all the operations in embodiments may be performed. Further, it should be appreciated that the embodiments may be changed or modified by a person of ordinary skill in the art, but these changes and modifications still fall within the spirit and scope of the embodiments.

1. A method comprising:
obtaining first information, wherein the first information comprises a mapping relationship between first task information and first bearer information; and
sending, to a network device through a first bearer indicated by the first bearer information, data information that is of a first task and that is indicated by the first task information.

2. The method according to claim 1, wherein the first information further comprises a mapping relationship between second task information and the first bearer information, and the first task information is different from the second task information; and
the data information of the first task further comprises the first task information.

3. The method according to claim 1, further comprising:
processing a first artificial intelligence (AI) model configured to execute the first task, wherein the data information of the first task further comprises a processing result of processing the first AI model.

4. The method according to claim 3, further comprising:
receiving first configuration information from the network device, wherein the first configuration information comprises a mapping relationship between the first task information and a processing manner of the AI model or a mapping relationship between the first bearer information and a processing manner of the AI model; and
processing the first AI model configured to execute the first task comprises:
processing the first AI model based on the processing manner that is of the AI model and that corresponds to the first task information; or
processing the processing manner of the AI model based on the processing manner that is of the AI model and that corresponds to the first bearer information.

5. The method according to claim 4, wherein processing manner of the AI model comprises a switch configuration of the AI model and/or a parameter configuration of the AI model, wherein
the switch configuration of the AI model is on or off, and, when the switch configuration of the AI model is on, the switch configuration of the AI model indicates to process the first AI model; or
when the switch configuration of the AI model is off, the switch configuration of the AI model indicates not to process the first AI model.

6. The method according to claim 4, wherein the processing manner of the AI model comprises a switch configuration and/or a parameter configuration of one or more of model compression, model pruning, model security, model privacy, inference, data processing, or training.

7. The method according to claim 3, wherein the data information of the first task further comprises format information, and the format information indicates a format of the processing manner.

8. The method according to claim 1, wherein the first bearer information comprises one or more of a type of the first bearer, an identifier of the first bearer, and a logical channel identifier (LCID) of the first bearer.

9. The method according to claim 1, wherein the data information of the first task comprises first indication information, and the first indication information indicates that the first bearer is a signaling bearer; or
the data information of the first task comprises second indication information, and the second indication information indicates that the first bearer is a data bearer.

10. The method according to claim 1, further comprising:
obtaining second configuration information, wherein the second configuration information comprises a mapping relationship between the first bearer information and quality of service (QoS) information; and
sending, to the network device through the first bearer indicated by the first bearer information, the data information of the first task that is indicated by the first task information comprising:
sending, to the network device based on the QoS information corresponding to the first bearer information through the first bearer indicated by the first bearer information, the data information of the first task that is indicated by the first task information, wherein the first bearer is the signaling bearer.

11. The method according to claim 1, wherein the first bearer is the signaling bearer or the data bearer, and an LCID of the signaling bearer is different from an LCID of the data bearer.

12. The method according to claim 1, wherein the data information of the first task comprises third indication information, the third indication information indicates the network device to transparently transmit the data information of the first task, and the first bearer is a data bearer; or
the data information of the first task comprises fourth indication information, the fourth indication information indicates the network device to terminate the data information of the first task, and the first bearer is a data bearer.

13. The method according to claim 1, wherein the data information of the first task further comprises one or more of information comprised in the first bearer information and/or one or more of information comprised in the first task information, wherein
the one or more of the information comprised in the first bearer information and/or the one or more of the information comprised in the first task information indicates whether the network device terminates the first bearer, and the first bearer is a data bearer.

14. The method according to claim 1, wherein the data information of the first task further comprises one or more of a node type, a node identifier, the first bearer information, and the first task information, and the node type, the node identifier, the first bearer information, and the first task information indicate a node that terminates the data information of the first task.

15. The method according to claim 1, further comprising:
obtaining third configuration information, wherein the third configuration information comprises a mapping relationship between the first bearer information and a node, and the node is configured to terminate the first bearer; and/or
the third configuration information comprises a mapping relationship between the first task information and a node, and the node is configured to terminate the first bearer.

16. A non-transitory computer-readable storage medium, wherein the non-transitory computer-readable storage medium is coupled to one or more processors and storing programming instructions for execution by the one or more processors, the programming instructions instruct the processor to:
obtain first information, wherein the first information comprises a mapping relationship between first task information and first bearer information; and
send, to a network device through a first bearer indicated by the first bearer information, data information that is of a first task and that is indicated by the first task information.

17. The non-transitory computer-readable storage medium according to claim 16, wherein the first information further comprises a mapping relationship between second task information and the first bearer information, and the first task information is different from the second task information; and
the data information of the first task further comprises the first task information.

18. The non-transitory computer-readable storage medium according to claim 16, wherein the programming instructions further instruct the processor to:
process a first artificial intelligence (AI) model configured to execute the first task, wherein the data information of the first task further comprises a processing result of processing the first AI model.

19. The non-transitory computer-readable storage medium according to claim 18, wherein the programming instructions further instruct the processor to:
receive first configuration information from the network device, wherein the first configuration information comprises a mapping relationship between the first task information and a processing manner of the AI model or a mapping relationship between the first bearer information and a processing manner of the AI model; and
processing the first AI model configured to execute the first task comprises:
processing the first AI model based on the processing manner that is of the AI model and that corresponds to the first task information; or
processing the processing manner of the AI model based on the processing manner that is of the AI model and that corresponds to the first bearer information.

20. The non-transitory computer-readable storage medium according to claim 19, wherein the processing manner of the AI model comprises a switch configuration of the AI model and/or a parameter configuration of the AI model, wherein
the switch configuration of the AI model is on or off, and, when the switch configuration of the AI model is on, the switch configuration of the AI model indicates to process the first AI model; or
when the switch configuration of the AI model is off, the switch configuration of the AI model indicates not to process the first AI model.
